(19) United States
(12) Patent Application Publication
(10) Pub. No.: US 2007/0080563 A1
(43) Pub. Date: Apr. 12, 2007

(54) Pillar on a motor vehicle

(75) Inventors: Konrad Eipper, Rottenburg (DE); Arndt Gerick, Ulm (DE); Konrad Goetz, Karlsruhe (DE); Tilmann Haug, Weissenhorn (DE); Wolfgang Kleinekathoefer, Waldstetten (DE); Karl Weisskopf, Rudersberg (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/576,080

(22) PCT Filed: Sep. 17, 2004
(86) PCT No.: PCT/EP04/10447

§ 371 Date: Dec. 27, 2006

(30) Foreign Application Priority Data
Oct. 16, 2003 (DE) 103 48 127.3

(51) Int. Cl. B62D 25/04

(52) U.S. Cl. 296/193.06

(57) ABSTRACT

An A-pillar on a motor vehicle is provided with a windshield flange for the securing of a windshield. The A-pillar is of single-part design in the region of the windshield and a wall region forming the windshield flange bounds a hollow cross section of the A-pillar. The windshield can be integrated indirectly in the A-pillar, which leads to a reduction in viewing angle obscuration.

This application is a national phase application of International application PCT/EP2004/010447 filed Sep. 17, 2004 and claims the priority of German application No. 103 48 127.3, filed Oct. 16, 2003, the disclosure of which are expressly incorporated by reference herein.

### BACKGROUND AND SUMMARY OF THE INVENTION

The invention relates to an A-pillar on a motor vehicle.

The supporting pillars of a motor vehicle contribute particularly to the strength of the stiffness of the vehicle body. In particular in the case of convertibles, the pillars, in particular also the A-pillar, fulfill the object of protecting the occupants in the event of the vehicle overturning. It is necessary in this case that the A-pillar is not pressed in during a conventional overturning of the vehicle.

This requirement is conventionally achieved by the fact that, especially in the case of convertibles, a steel tube is fitted into the A-pillar in order to increase the strength. Sheet-metal shells are arranged around the steel tube and are joined together at flanges to form a closed A-pillar.

This complicated construction, which comprises the steel tube and a sheet-metal shell structure, in which, as a rule, a plastic covering is also provided for the A-pillar, leads to the A-pillar considerably obscuring the driver's field of view. This obscuring of the driver's field of view is called viewing angle obscuration. To reduce the viewing angle obscuration, it is constantly endeavored to reduce the cross section of the A-pillar, in which case a compromise always has to be made with regard to the deformation strength of the A-pillar.

An object of the invention is to provide an A-pillar for a motor vehicle which has a reduced viewing angle obscuration in comparison to the prior art and at the same time provides increased safety in a crash.

Other objects, advantages and novel features of the present invention will become apparent from the following detailed description of the invention when considered in conjunction with the accompanying drawings for example.

An A-pillar according to the invention has a windshield flange which is suitable for the securing of a windshield. In this case, the windshield flange runs essentially along the A-pillar and has an essentially uniform cross section along its profile.

The invention is distinguished in that the A-pillar is of single-part design in the region of the windshield. A single-part design of the A-pillar renders superfluous a fold which is otherwise customary in the prior art and at which two half shells of an A-pillar are placed together by joining. Omission of this fold reduces the overall cross section of the A-pillar, which contributes to a reduction in the viewing angle obscuration.

This fold is usually used at the same time as a windshield flange for the windshield. In the design according to the invention, the windshield flange is integrated in the cross section of the A-pillar. This means that the wall region which forms the windshield flange at the same time bounds the hollow cross section of the A-pillar. The windshield therefore bears directly against the A-pillar and is secured therein. The omission of the fold customary in the prior art and the integration of the windshield flange in the A-pillar likewise contribute to reducing the viewing angle obscuration.

The term viewing angle obscuration signifies a measure of the extent to which the A-pillar obscures the all round view, i.e. the viewing angle of the driver. On account of the different sitting positions of different drivers and the different viewing angle obscuration arising as a result, complex computational models are prepared which define the viewing angle obscuration in reproducible form. One of these models is EEC standard 77/649, another model is found in SAE J 10 50.

The A-pillar according to the invention enables a reduction in the viewing angle obscuration according to EEC 77/649 by approximately 2 to 3 degrees to be obtained.

In an embodiment of the invention, the windshield flange is formed by an indentation, which runs along the A-pillar, in the cavity cross section of the A-pillar. This embodiment enables the windshield to be placed in a simple manner from the outside onto the A-pillar and to be adhesively bonded. In an advantageous embodiment of this indentation in the A-pillar, the windshield flange is completely formed by this indentation.

The A-pillar has particularly high strength if it is produced from cast steel. The casting of the steel also advantageously facilitates the single-part production according to the invention of the A-pillar in the region of the windshield.

Particularly high strength and good corrosion resistance are obtained if the A-pillar is produced from a chromium-nickel special steel.

A suitable production process for the A-pillar is a low-pressure casting process, in which in particular steel is pressed by a gas pressure into the casting molds. This process is particularly readily suitable for producing large components, such as, for example, an A-pillar, with comparatively small wall thicknesses. The wall thicknesses realized for the A-pillar according to the invention are generally between 1.6 mm and 8 mm, preferably between 1.6 mm and 4 mm, particularly preferably between 1.6 mm and 3 mm.

Other objects, advantages and novel features of the present invention will become apparent from the following detailed description of the invention when considered in conjunction with the accompanying drawings for example.

### BRIEF DESCRIPTION OF THE DRAWINGS

FIG. 1 shows a diagrammatic illustration of an A-pillar in accordance with an embodiment of the present invention,

FIG. 2 shows a cross section through an A-pillar with integrated windshield flange and a windshield in accordance with an embodiment of the present invention, and

FIG. 3 shows a conventional multipart A-pillar according to the prior art.

### DETAILED DESCRIPTION

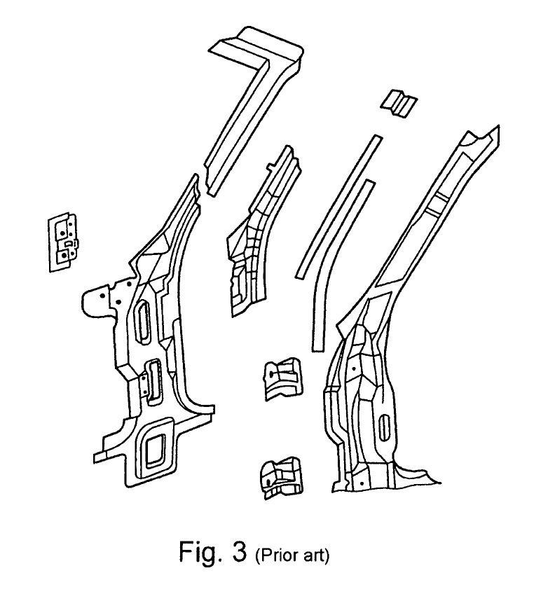

FIG. 1 illustrates a typical A-pillar 2. The illustration of the A-pillar 2 here is restricted in the upper region of the A-pillar 2. In principle, an A-pillar 2 (not illustrated here) may also be of single-part design in such a manner that it runs into a lower region of the vehicle where it is connected to a sill. An A-pillar constructed in this manner is depicted by way of example in the form of the prior art in FIG. 3.

The A-pillar illustrated in FIG. 3 shows an A-pillar according to the prior art. It is composed of a plurality of individual sheet-metal shells and sheet-metal parts which are not provided here with reference numbers. Steel tubes are still inserted into the assembled sheet-metal shells to reinforce the A-pillars. When the sheet-metal parts according to FIG. 3 are joined, which takes place as a rule by spot welding, a joining fold is always necessary. This joining fold points outward as seen from a cavity of the A-pillar. As a rule, this joining fold is used as the flange for the windshield.

By contrast, the A-pillar 2 in FIG. 1 is of single-part design. It has a windshield flange 4 in which a windshield 6 (not illustrated in FIG. 1) can be inserted.

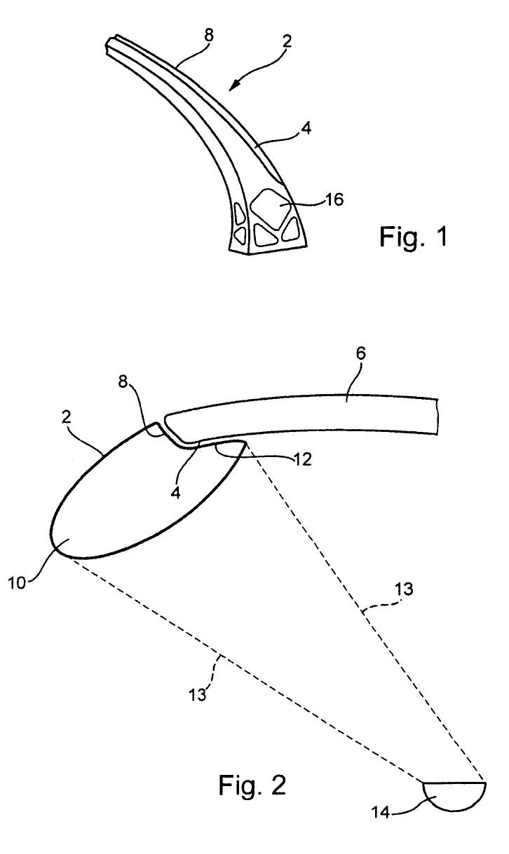

FIG. 2 illustrates a sectional illustration through the A-pillar and through the windshield. The A-pillar 2 has the windshield flange 4 which, in this embodiment, is illustrated in the form of an indentation 12. A wall region 8 which forms the windshield flange 4 at the same time bounds the hollow cross section 10 of the A-pillar 2. This means that the windshield flange 4 is integrated in the hollow cross section 10 of the A-pillar, with the formation of an additional fold being omitted.

FIG. 2 likewise illustrates the manner in which the windshield 6 is inserted into the windshield flange 4. The windshield 6 is preferably adhesively bonded into the windshield flange 4. The dashed lines 13 indicate the extent to which the viewing angle, as seen from a sketched driver's position 14, is obscured by the A-pillar 2. In this case, it is to be noted that the angle which the two dashed lines 13 enclose is not identical to the viewing angle obscuration.

The production of the A-pillar 2, as illustrated in FIGS. 1 and 2, preferably took place by a low-pressure casting process. One possible process here is “FONTE MINC (FM)”. This is a low-pressure process casting counter to gravity, using a sand mold. An advantage of this process is the rapid filling of the mold in a manner low in turbulence. A further possibility of producing the low-pressure casting is to apply a gas pressure to the side of the melt, the gas pressure causing the melt to be pressed into a sand mold.

These low-pressure casting processes are suitable in particular when ferrous metals are used. It is also possible here for special steels, for example high-alloy chromium-nickel steels, such as the special steel Nitronic 19D, to be cast in an advantageous manner. This production process can likewise realize a small wall thickness which is not customary for casting of steel. The wall thickness of the A-pillar 2 according to the invention shown in FIG. 1 is between 1.6 mm and 6 mm. However, the largest region of the A-pillar has walls between 1.6 mm and 3 mm. By means of these low wall thicknesses, paired with the very high strength of the steel used, which has a tensile strength (Rm) of above 600 N/mm² with a modulus of elasticity of virtually 200 kN/mm², can result in a very compact construction of the A-pillar.

The compact construction of the A-pillar with the small wall thicknesses leads to a significant reduction in the weight of the component. This process can be used to produce A-pillars which weigh between 4 kg and 6 kg. At the same time, the compact construction of the A-pillar leads to the viewing angle obscuration of 6 degrees, as is customary in the case of conventional vehicles, being reduced to 4 degrees. EEC standard 77/649 was taken as a basis for this measurement.

The A-pillar, as illustrated in FIG. 2, is bionically optimized in accordance with the computer aided optimization (CAO) method or in accordance with the soft kill option (SKO) method. This means that, based on a normal loading state, the lines of force in the A-pillar are calculated and the thickness of the component is increased along the lines of force. Outside the calculated lines of force, the thickness of the material is minimized. This leads in turn to the material at this point being able to be thinner or even entirely left open. This leads in turn, for example, to cutouts 16 in FIG. 1, which are illustrated in the A-pillar 2. These optimization methods make it possible to further reduce both the weight of the component and the cross section of the A-pillar, which in turn contributes to an improvement in the viewing angle obscuration.

In principle, the A-pillar 2 according to the invention can also be produced by other production processes. For example, “internal high-pressure forming (IHF)” is appropriate as the production process. However, this process has the disadvantage of only enabling uniform wall thicknesses to be obtained, which leads to it not being possible for the advantages of bionic optimization to be used. This leads in turn to an increase in the weight of the component, since all of the regions of the A-pillar are configured with the maximum necessary wall thickness.

A further process which is suitable for the production of the A-pillar according to the invention is, for example, aluminum or magnesium diecasting. However, taking the specific strength of the materials magnesium and aluminum into consideration, the A-pillar would have to be of such thick configuration in its wall region that the advantage of weight over the steel casting would be wasted and an A-pillar of aluminum and magnesium would therefore be heavier than one made from steel casting.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-7. (canceled)

8. An A-pillar of a motor vehicle, comprising:
an A-pillar formed by a single member at least in a region of a windshield flange formed on said member for the securing of a windshield, wherein
a wall region forming the windshield flange (4) bounds a hollow cross section of the A-pillar.

9. The A-pillar as claimed in claim 8, wherein the windshield flange is formed by an indentation in the hollow cross section of the A-pillar.

10. The A-pillar as claimed in claim 9, wherein the windshield flange is completely formed by an indentation in the hollow cross section of the A-pillar.

11. The A-pillar as claimed in claim 8, wherein the A-pillar is produced from cast steel.

12. The A-pillar as claimed in claim 9, wherein the A-pillar is produced from cast steel.

13. The A-pillar as claimed in claim 10, wherein the A-pillar is produced from cast steel.

14. The A-pillar as claimed in claim 11, wherein the A-pillar is produced from a chromium-nickel steel.

15. The A-pillar as claimed in claim 12, wherein the A-pillar is produced from a chromium-nickel steel.

16. The A-pillar as claimed in claim 13, wherein the A-pillar is produced from a chromium-nickel steel.

17. The A-pillar as claimed in claim 8, wherein the A-pillar is produced by low-pressure casting.

18. The A-pillar as claimed in claim 11, wherein the A-pillar is produced by low-pressure casting.

19. The A-pillar as claimed in claim 14, wherein the A-pillar is produced by low-pressure casting.

20. The A-pillar as claimed in claim 8, wherein the A-pillar has wall thicknesses of between 1.6 mm and 6 mm.

21. The A-pillar as claimed in claim 11, wherein the A-pillar has wall thicknesses of between 1.6 mm and 6 mm.

22. The A-pillar as claimed in claim 14, wherein the A-pillar has wall thicknesses of between 1.6 mm and 6 mm.

23. The A-pillar as claimed in claim 17, wherein the A-pillar has wall thicknesses of between 1.6 mm and 6 mm.
